(19) United States
(12) Patent Application Publication
(10) Pub. No.: US 2022/0012743 A1
(43) Pub. Date: Jan. 13, 2022

(54) AUTHENTICATION ELECTRONIC INFRASTRUCTURE

(71) Applicant: Payfone, Inc., d/b/a Prove, New York, NY (US)

(72) Inventors: Oliver Thomas Snell, New York, NY (US); Michael Stearne, Bellmawr, NJ (US); Robert E. Danielson, San Rafael, CA (US); Melissa Harbaugh, Lawrenceville, NJ (US); Mai Xuan Hoang, Denver, CO (US)

(21) Appl. No.: 17/372,493

(22) Filed: Jul. 11, 2021

Related U.S. Application Data
(60) Provisional application No. 63/050,853, filed on Jul. 12, 2020.

(51) Int. Cl. G06Q 20/40; H04W 12/72; G06Q 20/32; H04W 8/26; H04W 8/18

(52) U.S. Cl. CPC G06Q 20/4016; H04W 12/72; H04W 8/18; H04W 8/26; G06Q 20/322

(57) ABSTRACT

Briefly, example methods, apparatuses, and/or articles of manufacture are disclosed that may be implemented, in whole or in part, using one or more computing devices to receive at a display device, electronic signals that relate to a transacting party operating a communications device, to access by a computing device in communication with the display device, electronic records to determine whether one or more risk events has occurred with respect to the communications device, and to generate signals indicating a determination as to whether a transaction initiated by the transacting party is to proceed based, at least in part, on a score dependent upon the one or more risk events indicated by the electronic records.

### RELATED APPLICATIONS

This application claims priority to U.S. provisional patent application No. 63/050,853, filed Jul. 12, 2020, which is incorporated by reference herein in its entirety and for all purposes.

### BACKGROUND

### 1. Field

The present disclosure relates generally to electronic and/or communication infrastructures and associated approaches toward authorizing an electronic transaction based, at least in part, on risk events that relate to a transacting party's communications device.

### 2. Information

The World Wide Web or simply the Web, as provided by the Internet, has grown rapidly in recent years at least partially in response to the wide variety of types of transactions that can be performed or enabled via the Internet. In an environment in which electronic or Internet-based commerce takes place on a grand scale, occurrences of fraud and deception, unfortunately, can frequently occur. Thus, to reduce the instances of fraud and deception, various fraud-protection processes and/or procedures may be utilized. Such procedures may be employed, for example, in connection with every-day on-line or electronic transactions, including financial transactions, establishing lines of credit, transactions relating to purchases of in-store goods and/or services, or the like.

In addition, in an environment in which various electronic devices typically used for communications, such as cellular telephones, tablets, laptop computers, etc., have become ubiquitous, the types of possible fraud have, in at least some instances, become more complex, such as perhaps involving use and/or knowledge of complex technology, for example, related to the particular hardware and/or software platforms associated with such cellular telephones, tablets, laptop computers, etc. Thus, attempts to reduce the instances of fraud and deception, which may involve, for example, use of various electronic devices, continues to be an active area of investigation.

### SUMMARY

One general aspect concerns the method involving receiving, at a display device, electronic signals that relate to a transacting party operating a communications device, accessing, by a computing device in communication with the display device, electronic records to determine whether one or more risk events has occurred with respect to the communications device. The method may additionally include generating signals indicating a determination as to whether a transaction initiated by the transacting party is to proceed based, at least in part, on a score dependent upon the one or more risk events indicated by the electronic records.

In particular embodiments, the communications device includes a communications device wherein the one or more risk events correspond to the porting of a communications device identifier (e.g., a mobile telephone number), removal and/or replacement of a subscriber identity module (SIM) of the communications device, or one or more risk events related to tenure of the communications device. In particular embodiments, the method further includes combining a risk score corresponding to the porting of a communications device identifier, with a risk score corresponding to the removal and/or the replacement of the subscriber identity module (SIM) of a communications device, and with the one or more risk events related to tenure of a communications device to form a composite risk score. In particular embodiments, authenticating the transacting party operating a communications device is based, at least in part, on the composite risk score exceeding a threshold, such as a lower threshold. In particular embodiments, the threshold corresponds to a configurable threshold, the configurable threshold being selected based, at least in part, on a transaction initiated by the transacting party. In particular embodiments, authenticating the transacting party is additionally based on a telephone number, or other type of identifier corresponding to the communications device, matching with one or more specified forms. In particular embodiments, the method may include accessing, by the computing device in communication with the display device, prior to authenticating the transacting party, one or more physical addresses corresponding to the transacting party. In particular embodiments, the method may include receiving an indication that the one or more physical addresses corresponding to the transacting party corresponds to at least one physical address provided by the transacting party. In particular embodiments, the method may include accessing, by the computing device in communication with the display device, prior to authenticating the transacting party, one or more email addresses corresponding to the transacting party. In particular embodiments, the method may include receiving an indication that the one or more email addresses corresponding to the transacting party corresponds to at least one email address provided by the transacting party. In particular embodiments, the method may include initiating, by the computing device in communication with the display device, conveying or transmitting a text message to the communications device. The message may include a hyperlink, at least in some embodiments. The method may additionally include receiving, by the computing device in communication with the display device, an indication that the transacting party has acknowledged receipt of at least a portion of the text message. The method may additionally include initiating, by the computing device in communication with the display device, transmission of a one-time password to the transacting party via a wireline telephone. The method may additionally include determining by the computing device in communication with the display device, that the one-time password conveyed to the transacting party matches the one-time password provided by the transacting party. The method may additionally include determining whether a transaction initiated by the transacting party is to proceed based on communications device behavior, authorizing a transacting party to engage in the transaction, and/or authenticating the transacting party.

In some embodiments, in lieu of requesting and/or displaying a physical address of a transacting party, an abridged version of a physical address may be requested/displayed. For example, in one or more embodiments, a street name, such as Main Street, but not a house number, for example, may be displayed. In another embodiment, a city or township may be displayed (such as Anytown USA) may be displayed, without display of a street name, house number, or other specific, identifying parameters. In certain embodiments, refraining from displaying specific information of a transacting party may address privacy concerns. It should be noted that any abridged or reduced portion of a physical address may be displayed, such as a partial address, and claimed subject matter is not limited in this respect. In some instances, a unique code, or portion thereof, may be displayed so as to uniquely identify a transacting party without displaying details of the transacting party's physical address.

Another general aspect may involve a method including receiving, at a display device, electronic signals that relate to a transacting party operating a communications device. The method may additionally involve accessing, by a computing device in communication with the display device, electronic records to determine whether one or more risk events has occurred with respect to the communications device. The method may additionally include rejecting a transaction initiated by the transacting party based, at least in part, on the one or more risk events indicated by the electronic records. In particular embodiments, the communications device may include a communications device and the one or more risk events corresponds to the porting of an identifier (e.g., a telephone number) of a communications device, removal and/or replacement of a subscriber identity module (SIM) of the communications device, or one or more risk events related to tenure of the communications device. In particular embodiments, risk score, which may correspond to the porting and identifier (e.g., a telephone number) of a communications device, may be combined with a risk score corresponding to the removal and/or replacement of the subscriber identity module (SIM) of the communications device, and with the one or more risk events related to tenure of the communications device to form a composite risk score. In particular embodiments, the transacting party operating the communications device is based, at least in part, on the composite risk score falling below a threshold, such as a lower threshold. In particular embodiments, the threshold corresponds to a configurable threshold, in which the configurable threshold may be selected based, at least in part, on a transaction initiated by the transacting party. In particular embodiments, rejecting the transacting party is additionally based on a telephone number corresponding to the communications device failing to match with one or more specified forms. Particular embodiments may include accessing, by the computing device in communication with the display device, prior to rejecting the transacting party, one or more physical addresses corresponding to the transacting party. Particular embodiments may include receiving an indication that the one or more physical addresses corresponding to the transacting party fails to correspond to at least one physical address provided by the transacting party. Particular embodiments may include accessing, by the computing device in communication with the display device, prior to rejecting the transacting party, one or more email addresses corresponding to the transacting party. Particular embodiments may include receiving an indication that the one or more email addresses corresponding to the transacting party fails to correspond to at least one email address provided by the transacting party. Particular embodiments may include initiating, by the computing device in communication with the display device, conveying a text message to the communications device. A text message may comprise a hyperlink. In particular embodiments, the method may include receiving, by the computing device in communication with the display device, an indication that the transacting party has failed to acknowledge receipt of at least a portion of the text message. Particular embodiments may include initiating, by the computing device in communication with the display device, conveying a one-time password to the transacting party via a wireline telephone. Particular embodiments may include determining by the computing device in communication with the display device, that the one-time password conveyed to the transacting party fails to match the one-time password provided by the transacting party.

Another general aspect refers to an apparatus may include at least one processor communicatively coupled to at least one memory to access, by the at least one processor, electronic records to determine whether one or more risk events has occurred with respect to a communications device of a transacting party. The at least one processor may additionally authorize or reject the transaction based, at least in part, on the one or more risk events indicated by the electronic records. In one embodiment, the communications device comprises a communications device. In particular embodiments, the one or more risk events may correspond to the porting of an identifier (e.g., a telephone number) corresponding to the communications device, removal and/or replacement of a subscriber identity module (SIM) of the communications device, or one or more risk events related to tenure of the communications device. In particular embodiments, authorization or rejection of a transaction may be based on a configurable threshold, in which the configurable threshold is selected based, at least in part, on a transaction initiated by the transacting party. In particular embodiments, the at least one processor communicatively coupled to the at least one memory are to authorize the transaction based, at least in part, on the risk score exceeding a configurable threshold. In particular embodiments, the at least one processor communicatively coupled to the at least one memory are to reject the transaction based, at least in part, on the risk score falling below the configurable threshold.

In one embodiment, an article may comprise a non-transitory storage medium having instructions stored thereon, and executable by a special purpose computing platform to access, by at least one processor coupled to at least one memory, electronic records to determine whether one or more risk events has occurred with respect to a communications device of a transacting party. The instructions may additionally authenticate or reject the transacting party based, at least in part, on the one or more risk events indicated by the electronic records. In particular embodiments, the communications device corresponds to a communications device. In addition, the one or more risk events may correspond to communications device number porting, removal and/or replacement of a subscriber identity module (SIM) of the communications device, or one or more risk events related to tenure of the communications device.

In particular embodiments, the stored instructions are additionally to combine a risk score corresponding to porting an identifier of the mobile communications device with a risk score corresponding to the removal and/or replacement of the SIM of the mobile communications device, and/or with the one or more risk events related to tenure of the mobile communications device, to form a composite risk score. In particular embodiments, the authentication or rejection of the transacting party is based, at least in part, on a relationship between the composite risk score and a lower risk threshold. In particular embodiments, the risk score corresponding to the porting of the identifier of the mobile communications device and the risk score corresponding to the removal and/or replacement of the SIM are related to a duration since the porting and a duration since the removal and/or replacement of the SIM. In particular embodiments, the stored instructions are to authorize or reject the transaction based on a configurable threshold, in which the configurable threshold is selected based, at least in part, on a transaction initiated by the transacting party. In particular embodiments, the configurable threshold pertains to a monetary amount involved in a financial transaction.

### BRIEF DESCRIPTION OF THE DRAWINGS

Claimed subject matter is particularly pointed out and distinctly claimed in the concluding portion of the specification. However, both as to organization and/or method of operation, features, and/or advantages thereof, it may best be understood by reference to the following detailed description if read with the accompanying drawings in which:

FIG. 1 is a schematic diagram illustrating an electronic communications infrastructure, involving wireless and wireline components, according to various embodiments.

FIG. 2 is a schematic diagram showing a transacting party utilizing a communications device to communicate with a customer service representative, according to an embodiment.

FIG. 3 is a schematic diagram illustrating an implementation of a computing device in an example computing environment.

FIG. 4 is a diagram representing an example user interface, which a customer service representative may view while authenticating the identity of a transacting party, according to an embodiment.

FIG. 5A is a diagram representing example behavior factors, which may be utilized by a customer service representative to authenticate the identity of a transacting party, according to an embodiment.

FIG. 5B is a diagram representing example ownership factors, which may be utilized by a customer service representative to authorize a transaction initiated by a transacting party, according to an embodiment.

FIG. 5C is a diagram representing example possession factors, which may be utilized by a customer service representative to authenticate a transacting party, according to an embodiment.

FIG. 6A is a first portion of a flow diagram illustrating an implementation of a Trust Portal electronic infrastructure, according to an embodiment.

FIG. 6B shows a second portion of a flow diagram illustrating an example implementation of a Trust Portal electronic infrastructure, according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification, are not necessarily intended to refer to the same implementation and/or embodiment or to any one particular implementation and/or embodiment. Furthermore, it is to be understood that particular features, structures, characteristics, and/or the like described, are capable of being combined in various ways in one or more implementations and/or embodiments and, therefore, are within intended claim scope. In general, of course, for the specification of a patent application, these and other issues have a potential to vary in a particular context of usage. In other words, throughout the disclosure, particular context of description and/or usage provides guidance regarding reasonable inferences to be drawn; however, likewise, the term “in this context” in general without further qualification refers at least to the context of the present patent application.

As previously alluded to, in an environment in which electronic communication devices, such as mobile cellular communications devices, voice over Internet protocol (VoIP) communications devices, etc., are ubiquitous, a user of an electronic communications device may wish to perform an electronic or digital transaction. Such transactions may involve completing and/or submitting an application for credit, engaging in an electronic financial transaction, purchasing a product and/or service, completing and/or submitting a loan application, completing and/or submitting one or more forms involved with applying for healthcare coverage (such as in connection with visiting a health provider's office), and/or engaging in a number of other types of transactions via an electronic communications device (or, more simply, a “communications device”). To facilitate these types of transactions, for example, a subscriber co-located with a communications device may establish an identity, such as may be established in connection with a communications device subscriber account with a cellular or mobile communications device services carrier, a VoIP services provider, or other type of communication services carrier. Establishment of an account associated with a communications device, utilizing, for example, a subscriber account identifier (e.g., a cellular telephone number), may permit an individual attempting to engage in an electronic or digital transaction to be authenticated, authorized, and/or verified. In some instances, in view of the nature of electronic or digital transactions, such as in an environment in which electronic or digital transactions are initiated via a communications network at any time and at any location, it may be useful to verify and/or authenticate a user relatively quickly, such as in a real-time manner, for example.

In many instances, it may be useful to verify and/or authenticate a user utilizing a slimmed-down or streamlined process in which a subscriber can be accurately verified and/or authenticated, for example, at a point-of-sale terminal in a retail environment. In some instances, an electronic communications device that supports or facilitates a slimmed-down or streamlined process for authenticating a user may delays in obtaining verification and/or authentication of a subscriber so as to permit a transacting party to engage and complete the transaction in a timely manner. In some instances, facilitating a slimmed-down or streamlined process for authenticating a customer May Permit Authentication In A Manner That enhances the consumer's purchasing experience as well as increases a merchant's ability to convey goods and services to a consumer without the consumer encountering significant delays in obtaining credit approval, processing loan applications, processing gift cards, etc. In still other instances, utilizing a slimmed-down or streamlined process to authenticate a user may permit the user to rapidly obtain his or her own medical records, as well as to permit a healthcare provider, for example, to quickly and expeditiously provide health-related parameters that may increase patient safety, ensure rapid delivery of healthcare, reduce cost, and so forth.

As a general matter, verification of possession of a communications device by a transacting party such as a party proximate or co-located with a communications device, may be desirable in response to a client institution or organization (e.g., a financial institution, a brokerage, a healthcare provider, etc.) seeking to determine and/or prove identity of the transacting party (e.g., a mobile subscriber). Proving possession (or at least gaining a threshold level of confidence of possession) of a communications device, as such relates to a transacting party, may involve establishing a correspondence between the transacting party and a subscriber account identifier. In this context, correspondence, association, and/or similar terms refer to a persistent, continuing, and objectively verifiable relationship between the transacting party in possession of, for example, a particular communications device, such as a mobile communications device. Thus, a unique subscriber account identifier may be employed to signify and/or identify a particular transacting party. In this context, the term “mobile communications device identity” and/or similar terms refer to an identity that leverages a mobile communications device account relationship (also referred to as a correspondence and/or association) of a subscriber as a source of authentication, authorization, and/or verification of a transacting party. Also in this context, the term “mobile subscriber device account” and/or similar terms refer to a mobile communication services account. The terms “mobile communications services,” “mobile communications device carrier,” and “mobile network operator” may be used interchangeably. Furthermore, in this context, the term “mobile device services carrier,” “telecommunication services carrier,” “services carrier,” or simply “carrier” may refer to an entity of a communications infrastructure that provides wired and/or wireless communication services to the general public for a consideration, such as a monthly subscription fee.

In the context of the present disclosure, a “communication services carrier” may refer to a mobile communication services and/or mobile network operator. However, there are examples of carriers that do not correspond to mobile communications services and/or mobile network operators. Such instances may include wireline services providers such as, providers of services operating within the public switched telephone network (PSTN), which include wireline services for rotary dial telephones and/or telephones utilizing, for example, dual tone multi-frequency (DTMF) signaling. Accordingly, the terms “services carrier” or simply “carrier” may be used in place of a communication services provider and/or wireline telephone services provider without a loss in meaning and/or understanding. In a given situation, particular context of usage should indicate if a term is being used in a general sense or in a narrower sense, such as referring to a mobile communication services, wireline services provider, mobile paging services provider, and/or mobile network operator, for example.

Other aspects of verifying and/or authenticating a mobile subscriber, such as by way of proving that a mobile subscriber is in possession of a communications device, are also described in greater detail hereinbelow. For example, in an embodiment, verifying the identity of and/or authenticating a transacting party may relate to a mobile account and/or a mobile subscriber. Further, a mobile subscriber account is one example of a type of subscriber account, especially in a networked electronic commerce environment, although claimed subject matter is not intended to be limited to online accounts or to mobile accounts. Rather, the term “account” or “subscriber account” in this context refers to a formal business arrangement between an entity, a person, or other party seeking to engage in a transaction, and a provider of the account, so as to accomplish a business purpose, for example. Thus, the term “account” is intended to be broadly interpreted as an arrangement that may provide certain privileges. In this context, privileges may involve access to credit, so as to facilitate the purchase of goods or services, access to secured content, such as premium entertainment content (e.g., premium sports, cinema, or other entertainment content). Also in this context, the term “secured content” is intended to be interpreted broadly so as to encompass any type of content available exclusively to certain individuals and/or certain entities in response to supplying certain credentials. Also in this context the term “parameters” refers numerical or other measurable factors capable of defining a system and/or to set conditions for operation of a system. Thus, for example, a set of parameters may include parameters stored via a non-transitory memory that forms or defines, at least in part, an electronic representation of the state of a mobile subscriber.

Likewise, an account may comprise various attributes. In this context, the term “subscriber account identifier” refers to a unique descriptor or feature associated with the account that defines certain aspects of the account. For example, in nonlimiting illustrations, a subscriber account identifier may refer to (or may at least be associated with) a mobile telephone number, a mobile subscriber unique alias, an international mobile subscriber identifier (IMSI), Integrated Circuit Card Identifier (ICC ID), a mobile services and/or other type of identifier (e.g., a unique identifier) employed in connection with the particular communication services provider. Mobile communications networks may include those compatible or compliant with a Global System for Mobile Communications (GSM) telecommunications network, for example. Other examples of mobile subscriber account identifiers may include an International Mobile Equipment Identifier (IMEI), Mobile Station International Subscriber Directory Number (MSISDN), a mobile equipment identifier or any other identifier that may be utilized to identify a mobile billing account number/identifier.

As discussed herein, a subscriber co-located with, or in possession of, a communications device may apply for an account, such as a credit account, for example, or may apply for any other type of account that imparts or confers particular privileges on the subscriber co-located or in possession of the communications device. In other instances, a subscriber co-located with a mobile device may attempt to engage in a financial transaction, for example, or may attempt to access secured information/secured content, just to name a few examples. In many instances, to obtain a privilege, such as access to credit, access to secured information (e.g., premium content streaming or other privileged entertainment) a mobile subscriber may be required to complete an application, such as an application for an account, an application for credit, an application for an increase in credit, or may be required to make another type of formal request, which involves the subscriber supplying subscriber-specific parameters. However, as previously alluded to, it may be advantageous for the subscriber, and for the institution providing privileges to the subscriber, for example, to verify or prove that, indeed, the subscriber is co-located with (or is in possession of) a particular communications device. By proving possession of a particular communications device, an institution may reduce the risk of a subscriber engaging in fraudulent behavior by impersonating a particular mobile subscriber and/or by obtaining another subscriber's mobile phone, such as by theft or by any other type of unscrupulous behavior. Further, by way of a communications device utilizing a streamlined or slimmed-down process of authenticating a user may permit rapid fraud detection which may result in the expeditious termination of a potentially fraudulent transactions.

Some example methods, apparatuses, and/or articles of manufacture are disclosed herein that may be used, in whole or in part, to facilitate and/or support one or more operations and/or techniques for Trust Portal electronic infrastructure, such as implemented in connection with a cellular mobile communications device (which may be referred to herein as a “communications device”) communicating with one or more computing devices via the one or more communication networks utilizing one or more communications protocols (e.g., network protocols, etc.) discussed herein. As will be seen, in some instances, one or more operations and/or techniques for implementing a Trust Portal electronic infrastructure may be implemented, at least in part, to audit behavior of a communications device of a transacting party, authorize a transacting party, and/or authenticate a transacting party so as to permit a particular electronic or on-line transaction to take place, as applicable and/or appropriate. Such electronic or on-line transactions, which may herein be referred to as simply “transactions,” may involve transactions related to one or more financial accounts, such as line-of-credit accounts, a mobile communication services account, a bank account, or the like. In this context, a “transacting party” refers to an entity (such as an individual, company, limited license partnership, juristic entity, and so forth) attempting to engage in and/or facilitate a transaction. A transacting party may comprise, for example, an individual, such as a customer (or potential customer), subscriber (or potential subscriber), purchaser (or potential purchaser), company or other business entity, juristic entity, or the like associated with a communications device that may be capable of originating and/or facilitating the transaction, such as via one or more electronic signals. Thus, it should be noted that throughout this document, terms pertaining to an identity of a transacting party, identity of a subscriber, identity of a customer, identity of an electronic device, and/or the like may be used interchangeably without loss of meaning and/or understanding unless particular context of usage suggests otherwise.

As is also discussed below, one or more operations and/or techniques for implementing a Trust Portal electronic infrastructure may allow a particular institution or organization, such as a bank, a retailer, a broker, automobile dealer, just to illustrate possible examples, to verify identity and/or trustworthiness of a transacting party so that a transaction may be allowed to occur. Depending on an implementation, one or more factors for implementing a Trust Portal electronic infrastructure may include, for example, assessing one or more risk events, which may correspond to behavior events involving auditing the behavior of a transacting party's communications device, just to illustrate one possible example. At times, one or more risk events may also correspond to ownership events, for example, which may pertain to behavior events involving a transacting party's attributes, such as physical addresses, email addresses, and so forth. In some instances, one or more risk events may also correspond to one or more possession events, for example such as events to determine whether a transacting party is in possession of a particular communications device. Risk events may be determined or assessed through interaction between, for example, a computing device under the control of a particular electronic process, such as part of a customer service representative accessing electronic records (for example, a database) to determine behavioral, ownership, and/or possession aspects of a transacting party's personal or stationary communications device. In this context, electronic records may correspond to electronic records stored in a database under the control of a communications services carrier, a public records database, a wireline telephone services carrier, just to name a few examples. Such risk events may influence a score of a transacting party. A score of a transacting party may be combined with one or more authorization aspects of a transacting party as well as authentication aspects of a transacting party which may influence or determine whether a specific transaction is permitted to occur.

Approaches toward reducing the risk of potential fraud relates to auditing, authorizing, and/or authenticating, a transacting party prior to completing a transaction, such as in place of or in addition to a typical log-in. In this context, the term “transaction” and/or similar terms refer to a set of electronic communications and/or actions between at least two parties that reciprocally affect and/or influence the at least two parties to the transaction. One or more entities that provide auditing, authorizing, and/or authenticating of the identity of a transacting party are referred to herein as auditing, authorizing, and/or authenticating entities and/or utilizing similar terms. This latter term is intended to encompass auditing, authorizing and/or authenticating agents that may exist as separate entities. For example, an auditing, authorizing, and/or authenticating agent may encompass entities that facilitate and/or support particular services, via organizing and/or participating in one or more transactions between two other parties (e.g., a bank and a communication services carrier, etc.). In this context, it is to be understood that such auditing, authorizing, and/or authenticating service, may be requested for a significant number of users for a significant number of possible situations. For example, millions, tens of millions, hundreds of millions, or even more requests may be submitted on a daily basis, for example. Therefore, uniform and practical approaches and/or processes, rather than unique, customized approaches and/or processes that may otherwise vary by request, may be desirable in response to receiving a large volume of auditing, authorizing, and/or authenticating requests.

As a general matter, auditing, authorizing, and/or authenticating of a transacting party, such as mobile authentication, may be desirable in response to an institution or organization (e.g., third party, etc.) wishing to verify or audit, authorize, and/or authenticate the identity of a transacting party (e.g., a subscriber to a communication services carrier). Auditing, authorizing, and/or authenticating may involve establishing a correspondence and/or association of a transacting party with a persistent communications device identifier, as demonstrated below through illustrative examples. In this context, a correspondence, association, and/or similar terms refer to a persistent, continuing and objectively verifiable relationship between a transacting party with a particular communications device. Thus, a communications device identifier may be employed to signify a particular transacting party. The term mobile communications device and/or similar terms in this context refers to an identity that relies on a communications device account relationship (also referred to as a correspondence and/or association) of a user as a source of auditing, authorizing, and/or authenticating a transacting party and is capable of being verified by another (e.g., a third-party auditing, authorizing, and/or authenticating entity). The term communications device account and/or similar terms in this context refer to a communication services provider account. Furthermore, in this context, the term “wireless carrier,” “common carrier,” or simply “carrier” refers to an entity in a telecommunications infrastructure that provides wired and/or wireless communication services to the general public for a consideration, such as a fee.

Further, an authenticator may utilize parameters obtained from a specific communications device to access one or more records relating to historical events with respect to the particular communications device. In particular embodiments, records relating to historical events relative to the particular communications device may be indicative of the reputation of the communications device. Thus, responsive to an authenticator obtaining records relating to historical events relevant to the particular communications device, the authenticator may report a measure of trust or trustworthiness with respect to a particular communications device. In some instances, a financial institution, for example, may utilize measures of trust or trustworthiness of a particular communications device to influence whether particular transactions should be permitted to take place. For example, responsive to an authenticator reporting a relatively low measure of trust or trustworthiness of a communications device, a financial institution may permit only low-value transactions (e.g., less than $100) to take place. In another example, responsive to an authenticator reporting a relatively high measure of trust or trustworthiness of a particular communications device, a financial institution may permit transactions of virtually any value to take place.

Thus, particular embodiments of claimed subject matter may allow a financial institution to be assured that an unscrupulous individual, who might be impersonating the owner of the particular communications device, for example, cannot complete a financial transaction. In many instances, a capability to rapidly preclude unscrupulous individuals from engaging in fraudulent financial transactions, such as by way of the fraudulent impersonation of a particular communications device account holder, operates to protect authentic account holders as well as financial institutions, content providers, healthcare institutions, and so forth. In addition, following an authenticator verifying and/or authenticating a particular subscriber, such as by way of determining that the subscriber is in possession of a specific communications device, particular embodiments of claimed subject matter may permit an authenticator to report to a financial institution, for example, a measure of trust and/or trustworthiness of a particular communications device. By way of reporting trust and/or trustworthiness to a financial institution, certain types of transactions may be permitted to occur while other types of transactions may be rejected. Preventing fraudulent transactions may bring about a reduction in instances of identity theft, fraud related to credit cards and/or other instruments, circumventing of parental controls, pirating of exclusive entertainment content, and so forth.

As previously noted, in particular embodiments, after verification of the identity of a particular communication services subscriber, an authenticator may access a data store to determine a reputation with respect to a communications device. In particular embodiments, a reputation with respect to a communications device may be negatively impacted (e.g., degraded) responsive to the communications device being associated with one or more risk events. Such risk events may include, but are not limited to, recent porting of a subscriber account identifier (e.g., a telephone number) associated with a communications device, recent replacement of a communications device, a recent request of a one-time-password associated with a communications device, removal/replacement of a SIM of a communications device, as well as any number of additional risk events associated with the device. In particular embodiments, a reputation of a communications device may be positively impacted (e.g., enhanced) responsive to the device having never been ported (or having not been ported for a prolonged period of time), having never undergone removal/replacement of a SIM (or having not undergone such removal/replacement of a SIM for a prolonged period of time), and so forth. It should be noted that claimed subject matter is intended to embrace risk events with respect to a communications device other than these, virtually without limitation.

Also in this context, the term “risk event” refers to a behavioral, ownership, and/or possession aspect of a communications device and/or a transacting party corresponding or associated with the communications device, which may be tracked within a database used for auditing, authorizing, and authenticating a transacting party, such as without a change of that identity (e.g., an identity stays the same despite these change events, etc.). It is noted that the foregoing provides a non-exhaustive list of illustrations of risk events. Furthermore, as the nature of mobile communications evolves, it is likewise possible that events that would qualify as risk events may come into practice in connection with mobile accounts that currently may not be occurring, for example. It is worth noting, as mentioned, the term attribute used with respect to an account is to be read broadly in this context (e.g., in comparison with attributes of a mobile account for use in identity verification).

Although the discussion that follows relates to any type of account, as a non-limiting illustration, mobile accounts shall be used for illustration. It is understood, of course, that claimed subject matter is intended to not be limited to examples provided primarily for purposes of illustration, since such examples may be oversimplified for purposes of comprehension, for example. As was mentioned previously, with respect to commerce, including, of course, mobile accounts, a risk of fraud and/or unauthorized actions taking place is present or at least a risk exists of attempts being made.

The following provides a few illustrative examples of accounts in which a risk of fraud and/or unauthorized actions may exist. A transacting party may log into a bank account via a web browser or an executable application on a communications device, for example. Thus, a bank and/or other financial institution, for example, may, as a result, such as in an example embodiment, employ an application programming interface (API) substantially compatible and/or substantially compliant with HTTP and/or HTTPS, including versions now known and/or to be later developed, and/or another suitable protocol (e.g., now known and/or to later be developed). In the foregoing example, a user may seek to take one or more actions with respect to an account, such as, for example, establishing an account, transferring funds, viewing a history of transactions, making a payment, updating personal content, etc.

As another illustration, a user may seek to log into an existing account with a merchant. Thus, a merchant may, as a result, seek as a form of payment, such as via a credit account (e.g., credit card) that may already be “on file” with the merchant. As yet another illustration, a user may seek to log onto a communications device, for example, to create, share and/or edit a file. Thus, accounts may exist with respect to security services, entities managing networks, and/or entities managing devices. As another example, a user may seek to access, via a communications device, files stored using a shared network drive. That is, in this example, a user provides files to be stored on servers accessible by various users. Thus, a software company may create an account for a user. For example, a secure file system may utilize a security layer in which a user enters a code, which may be stored via an application on the communications device, if the user seeks to access files from the secure file system.

Thus, as suggested, a user may seek to access an online account and a third party, such as those who may provide such an account, may seek to protect access appropriately at least in part for reasons of confidentiality. In an example, a software company and/or product (e.g., tax-preparation software) may have a user account established. One may also consider similar variations in which confidentiality may not be an aspect. For example, for premium content management, a user may seek to access content because he or she has an online newspaper subscription. In another variation, a user may desire to access content whether such content is personalized, such as may be uploaded through a social networking site, or not personalized, such as content available to a premium sports network. In another scenario, a user could be returning to a website and/or application, and the website or application could be dependent at least in part on binding a user with a website and/or with an application, such as via an account for the user. As another example, a user may ‘click’ a ‘click-to-call’ button of a website and/or application to reach customer care. Thus, a third party may comprise a customer care facility of an enterprise, for example, such as a care facility of a bank, in which an account is established. Yet another scenario may revolve around confidentiality associated with medical records of patients, such as compliance with HIPAA, the Affordable Care Act, Electronic Medical Records and/or other regulatory schemes. A variety of potential situations may arise in which a user may seek access to records, such as a patient, a company, such as for insurance, as an example, a hospital, a medical professional providing care, etc. Thus, again, a user or authorized agent may log into a user's medical record account that may exist online and/or be stored electronically, such as on a website. As yet another example, a variety of corporate programs, including as examples, airline mileage plus miles, gift cards, etc., in which value has been accumulated, may be managed as online accounts. Thus, all of the foregoing examples and many more accounts are subject to risk associated with fraud and/or unauthorized actions by a “bad actor” or “meddler.”

Continuing with this example, therefore, a meddler may desire to modify one or more attributes of a particular mobile account. For example, the meddler may desire to create a false identity as the owner of the account. As mentioned previously, one way to handle such risks may be to employ auditing, authorization, and/or authentication, such as may pertain to auditing, authorizing, and authenticating an individual associated with a communications device, which may include verifying trustworthiness of a transacting party, for example, via one or more appropriate processes and/or procedures. As was also indicated, at times, these or like auditing, authorizing, and/or authenticating processes and/or procedures may include communicating (e.g., exchanging, etc.) content related to a particular user and/or entity over one or more communications networks. For example, while transacting parties interact with an institution or organization, they may provide certain content, including personally identifiable information (PII) that can be used, at least in part, to verify their identity. Included in this content are often uniquely identifiable values that uniquely identify a person, for example, such identifiers may include but are not limited to a phone number, a Social Security number, or the like. Additionally, such an identifier may be comprised of a group of values, for example, such identifiers may include but are not limited to an address, a first name, a date of birth, or the like.

Thus, as will be discussed in greater detail below, in an implementation, one or more operations and/or techniques for implementing a Trust Portal electronic infrastructure may be implemented, at least in part, so as to audit, authorize, and authenticate the identity of a transacting party and/or assess the trustworthiness of a user of a particular account, for example, which may include a financial account, mobile communications device or other type of services account, or the like. As also discussed below, one or more operations and/or techniques for implementing a Trust Portal electronic infrastructure may allow a particular institution or organization, such a bank, just to illustrate one particular example, to determine trustworthiness of a transacting party so that a particular transaction may be permitted to occur.

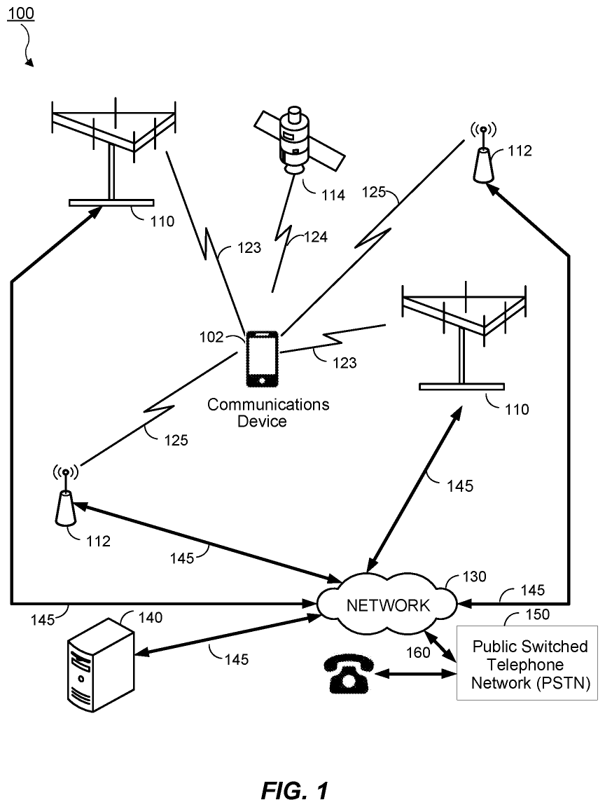

FIG. 1 is a schematic diagram illustrating features associated with an implementation of an example operating environment 100 capable of facilitating and/or supporting one or more processes and/or operations for implementing a Trust Portal electronic infrastructure. As was indicated, in some instances, one or more processes and/or operations to implement a Trust Portal electronic infrastructure may be implemented, at least in part, to verify the identity of a mobile subscriber utilizing a particular communication device, such as a mobile communications device, for example, referenced herein at 102. As used herein, “communications device,” may refer to any kind of special purpose computing platform and/or apparatus that may from time to time occupy a position or location that changes. In some instances, a communications device, such as a mobile communications device may, for example, be capable of communicating with other devices, mobile or otherwise, through wireless transmission or receipt of content according to one or more communication protocols. As a way of illustration, communications devices may include, for example, cellular telephones, smart telephones, personal digital assistants (PDAs), laptop computers, personal entertainment systems, tablet personal computers (PC), personal audio or video devices, personal navigation devices, Internet of Things (IoT) devices, or the like. It should be appreciated, however, that these are merely examples of communications devices that may be used, at least in part, to implement one or more operations and/or techniques for implementing/utilizing a Trust Portal electronic infrastructure, and that claimed subject matter is not limited in this regard.

It should be appreciated that operating environment 100 is described herein as a non-limiting example that may be implemented, in whole or in part, in the context of various electronic communications networks or combinations of such networks, such as public networks (e.g., the Internet, the World Wide Web), private networks (e.g., intranets), WWAN, wireless local area networks (WLAN, etc.), or the like. It should also be noted that claimed subject matter is not limited to a particular network and/or operating environment. For example, in some instances, an optical network may be used herein, in whole or in part, such as separately and/or in any suitable combination with one or more networks discussed herein. Thus, depending on an implementation, one or more operations and/or techniques for implementing/utilizing a Trust Portal electronic infrastructure may be performed, at least in part, in an indoor environment, an outdoor environment, or any combination thereof.

As illustrated, in an implementation, communications device 102 may, for example, receive or acquire satellite positioning system (SPS) signals 104 from SPS satellites 114. In some instances, SPS satellites 114 may be from a single global navigation satellite system (GNSS), such as the GPS or Galileo satellite systems, for example. In other instances, SPS satellites 114 may be from multiple GNSS such as, but not limited to, GPS, Galileo, Glonass, or Beidou (Compass) satellite systems. In certain implementations, SPS satellites 114 may be from any one several regional navigation satellite systems (RNSS) such as, for example, WAAS, EGNOS, QZSS, just to name a few examples.

At times, communications device 102 may, for example, transmit wireless signals to, or receive wireless signals from, a suitable wireless communication network. In one example, communications device 102 may communicate with a cellular communication network, such as by transmitting wireless signals to, or receiving wireless signals from, one or more wireless transmitters capable of transmitting and/or receiving wireless signals, such as a base station transceiver 110 over a wireless communication link 123, for example. Similarly, communications device 102 may transmit wireless signals to, or receive wireless signals from a local transceiver 112 over a wireless communication link 125. Base station transceiver 108, local transceiver 112, etc. may be of the same or similar type, for example, or may represent different types of devices, such as access points, radio beacons, cellular base stations, femtocells, or the like, depending on an implementation. Similarly, local transceiver 112 may comprise, for example, a wireless transmitter and/or receiver capable of transmitting and/or receiving wireless signals. For example, as will be seen, at times, local transceiver 112 may be capable of obtaining one or more observations from one or more other terrestrial transmitters.

In a particular implementation, local transceiver 112 may be capable of communicating with communications device 102 at a shorter range over wireless communication link 125 than at a range established via base station transceiver 110 over wireless communication link 123. For example, local transceiver 112 may be positioned in an indoor or like environment and may provide access to a wireless local area network (WLAN, e.g., IEEE Std. 802.11 network, etc.) or wireless personal area network (WPAN, e.g., Bluetooth® network, etc.). In another example implementation, local transceiver 112 may comprise a femtocell or picocell capable of facilitating communication via link 125 according to an applicable cellular or like wireless communication protocol. Of course, it should be understood that these are merely examples of networks that may communicate with communications device 102 over a wireless link, and claimed subject matter is not limited in this respect. For example, in some instances, operating environment 100 may include a larger number of base station transceivers 110, local transceivers 112, etc.

In an implementation, base station transceiver 110, local transceiver 112, etc. may communicate with servers 116, 118, or 120 over a network 130 via one or more links 124. Network 130 may comprise, for example, any combination of wired or wireless communication links. In a particular implementation, network 130 may comprise, for example, Internet Protocol (IP)-type infrastructure capable of facilitating or supporting communication between communications device 102 and one or more servers 116, 118, 120, etc. via local transceiver 112, base station transceiver 110, etc. In another implementation, network 130 may comprise, for example cellular communication network infrastructure, such as a base station controller or master switching center to facilitate and/or support mobile cellular communication with communications device 102. Servers 116, 118, and/or 120 may comprise any suitable servers or combination thereof capable of facilitating or supporting one or more operations and/or techniques discussed herein. For example, servers 116, 118, and/or 120 may comprise one or more database servers (e.g., for a data source, agent, identify verifier, carrier, etc.), update servers, back-end servers, management servers, archive servers, location servers, positioning assistance servers, navigation servers, map servers, crowdsourcing servers, network-related servers, or the like.

In particular implementations, communications device 102 may have circuitry or processing resources capable of determining a position fix or estimated location of communications device 102, initial (e.g., a priori) or otherwise. For example, if satellite signals 104 are available, communications device 102 may compute a position fix based, at least in part, on pseudorange measurements to four or more SPS satellites 114. Here, communications device 102 may compute such pseudorange measurements based, at least in part, on pseudonoise code phase detections in signals 104 acquired from four or more SPS satellites 114. In particular implementations, communications device 102 may receive from one or more servers 116, 118, or 120 positioning assistance data to aid in the acquisition of signals 104 transmitted by SPS satellites 114 including, for example, almanac, ephemeris data, Doppler search windows, just to name a few examples.

Even though a certain number of computing platforms and/or devices are illustrated herein, any number of suitable computing platforms and/or devices may be implemented to facilitate and/or support one or more techniques and/or processes associated with operating environment 100. For example, at times, network 130 may be coupled to one or more wired or wireless communication networks (e.g., WLAN, etc.) so as to enhance a coverage area for communications with communications device 102, one or more base station transceivers 110, local transceiver 112, servers 116, 118, 120, or the like. Network 130 may maintain links 160 with PSTN 150, so as to provide linkage between a wireless cellular telecommunications infrastructure and a wireline telecommunications system. In some instances, network 130 may facilitate and/or support femtocell-based operative regions of coverage, for example, via communications link 145. Again, these are merely example implementations, and claimed subject matter is not limited in this regard.

Thus, as was indicated, one or more operations and/or techniques for implementing a Trust Portal electronic infrastructure, such as discussed herein, may be implemented, at least in part, to allow a particular party, such as an institution or organization (e.g., a bank, etc.) to verify identity and/or trustworthiness of a transacting party by using various mobile communications device behavior, mobile communications device ownership, and mobile communications device possession. In some instances, this may, for example, be implemented by assessing risk events, which may call into question the identity of a transacting party. Such risk events may negatively impact the trustworthiness of the transacting party which may, give rise to a business entity, such as a bank, mobile communications device services provider, project, etc. denying certain types of transactions, such as financial transactions. Conversely, responsive to an absence of risk events, such transactions, account updates, access to content, for example, may be permitted to occur.

Thus, as was also indicated, in an implementation, such as in response to a user transacting or interacting with an institution or organization (e.g., a bank, etc.), the user may be required to provide certain content, including, for example, personally identifiable information (PII), among other. At times, this or like information may, for example, be used, in whole or in part, to authenticate or verify a user's identity, such as mobile communications device identity, just to illustrate one possible implementation. In some instances, included in this content are often uniquely identifiable values or identities that may uniquely identify a person, for example, such as a phone number, and email address, a physical address (for example, house number, street name, city, state, ZIP Code, and so forth) or the like, just to name a few examples. Additionally, an identifier may comprise, for example, of a group of values, such as an address, a first name, a date of birth, or the like.

As will be seen, in an implementation, an institution or organization (e.g., a bank, etc.) may want to verify this information as part of a transaction, for example, and so may pass the information (e.g., communicate electronically, etc.) to an underwriter who may assess risks associated with particular types of transactions. In some instances, to accomplish this, content from an institution or organization may need to be passed to a applicable data source, for example, or the data source would need to pass their content to an auditing, authorizing, and/or authenticating entity, which may include exchange of content over one or more communications links and/or networks. Thus, one or more operations and/or techniques for implementing a Trust Portal electronic infrastructure may be used, in whole or in part, assess the trustworthiness of a transacting party, which, in turn, may permit a transaction to occur.

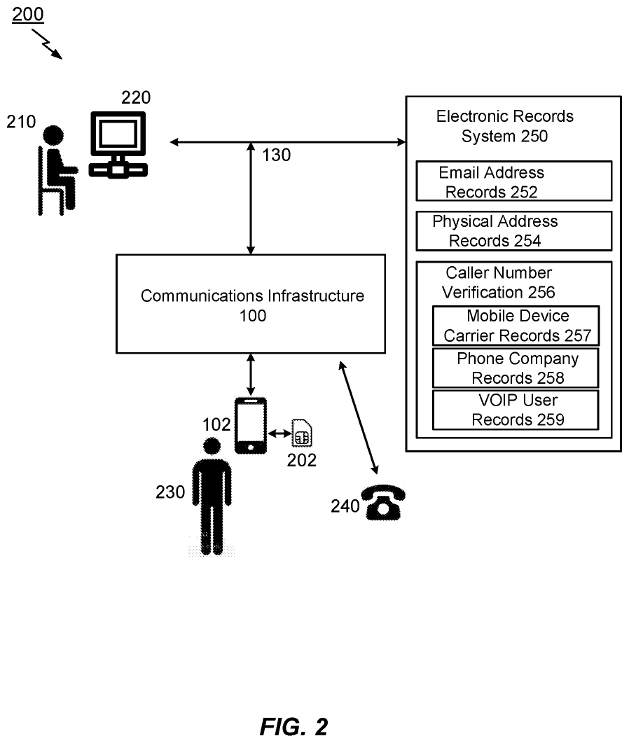

FIG. 2 is a schematic diagram showing a transacting party utilizing a mobile communications device, as one particular example, to communicate with a customer service representative, according to an embodiment 200. In the embodiment of FIG. 2, customer service representative 210 may operate computing device 220, which may include at least one processor coupled to a memory. Computing device 220 may incorporate a graphical display, mouse, headset, and other accessories, which may permit customer service representative 210 to interact with the computing device 220. Responsive to a telephone call placed by transacting party 230 via communications device 102, a display device coupled to computing device 220 may present details of communications device 102. Additionally, customer service representative 210 may receive audio signals from and transmit audio signals to transacting party 230. In the embodiment of FIG. 2, such audio signals may be communicated via network 130, which may represent an enterprise local area network (for example), to receive input signals from and to transmit output signals to communications infrastructure 100. Communications infrastructure 100 may operate in a manner similar to operating environment 100 discussed in relation to FIG. 1. It should be noted that although communications device 102 is depicted as corresponding to a mobile communications device, in some embodiments, communications device 102 may correspond to a voice over Internet protocol (VoIP) device, a landline telephone, or any other suitable communications device, and claimed subject matter is not limited in this respect.

It should be noted that customer service representative 210 may be implemented via a human entity, such as an employee of a financial institution, retailer, etc., and may perform a decision-making process to determine whether transacting party 230 is authorized to perform a transaction. However, in some embodiments, customer service representative 210 may be implemented via one or more electronic and/or computing processes, such as via one or more software modules executing computer-readable instructions that perform computer-implemented processes for determining whether transacting party 230 is authorized to perform a transaction. In some embodiments, a decision-making process performed by a financial institution may be aided by computer-readable instructions, thereby forming a hybrid approach comprising aspects of human decision-making as well as computer-assisted decision-making.

In the embodiment of FIG. 2, transacting party 230 may seek to initiate a transaction, such as any one of numerous types of financial transactions, including accessing funds, depositing funds, updating the account information of transacting party 230, accessing content, etc. In some instances, transacting party 230 may correspond to a transacting party attempting to deceive or to fraudulently engage in, for example, a financial transaction. In one example, transacting party 230 may attempt to fraudulently, and/or deceptively, obtain a credit card or line of credit from a financial institution. In such an example, customer service representative 210 may be tasked with auditing, authorizing, and/or authenticating the identity of transacting party 230. Responsive to such operations with respect to transacting party 230, customer service representative 210 may permit the transaction to occur. Conversely, responsive to an inability to audit, authorize, and/or authenticate transacting party 230, or in response to determining that transacting party represents greater than a threshold level of risk, customer service representative 210 may reject the transaction.

Responsive to receiving communication signals originated from communications device 102, such as via transacting party 230 dialing an appropriate telephone number (or otherwise establishing a communications channel between transacting party 230 and customer service representative 210), computing device 220 may access electronic records system 250. In particular embodiments, electronic records system 250 may represent an identity and access management company. However, electronic records system 250 may represent any other authenticating entity, and claimed subject matter is not limited in this respect. In the embodiment of FIG. 2, electronic records system 250 may utilize a telephone number, such as a telephone number corresponding to, and/or presented by, communications device 102 to obtain parameters relevant to communications device 102. Such parameters may be stored in a database of electronic records system 250. Parameters may be associated with or correspond to persistent attributes of communications device 102, such as a mobile communications device identifier. A mobile communications device identifier may correspond to: (1) an identifier of a mobile subscriber account with a communication services provider, (2) a mobile subscriber unique alias, (3) a mobile telephone number, (4) a mobile subscriber service provider; and/or (5) an international mobile subscriber identifier (IMSI), Integrated Circuit Card Identifier (ICC ID) and/or similar identifier employed or utilized in connection with a mobile network operator or a communication services provider. Such parameters may be located in, or accessed by, caller number verification module 256. In some instances, caller number verification module 256 may access mobile communications device carrier records module 257, phone company records 258, and/or VoIP user records 259. Electronic records system 250 may additionally include parameters of wireline telephone 240, which may operate via the PSTN.

Electronic records system 250 may include parameters that correspond to parameters stored in subscriber identity module (SIM) 202. In the embodiment of FIG. 2, SIM 202 may comprise a detachable or embedded smart card that is able to store subscription content of a user, and/or is also able to store a contact list. SIM 202 may comprise one or more integrated circuits adapted for storage of, for example, the IMSI number and its related key of communications device 102. The IMSI number and its related key, may be used to identify and authenticate subscriber devices so that a communications infrastructure can provide communications services to communications device 102.

In addition, electronic records system 250 may include, or be capable of accessing, email address records and/or physical address records (such as via physical address records module 254) corresponding to transacting party 230. Electronic records system 250 may include parameters that link or establish a correspondence between a particular communications device 102 and transacting party 230. Such parameters may include an email address of transacting party 230, a physical address of transacting party 230, as appropriate and/or applicable, and so forth.

It should be noted that although the embodiment of FIG. 2 shows customer service representative 210 interacting with computing device 220, so as to permit the customer service representative to audit, authorize, and/or authenticate, and consequently to approve (or to deny) a transaction, activities performed by the customer service representative may be performed by computing device 220.

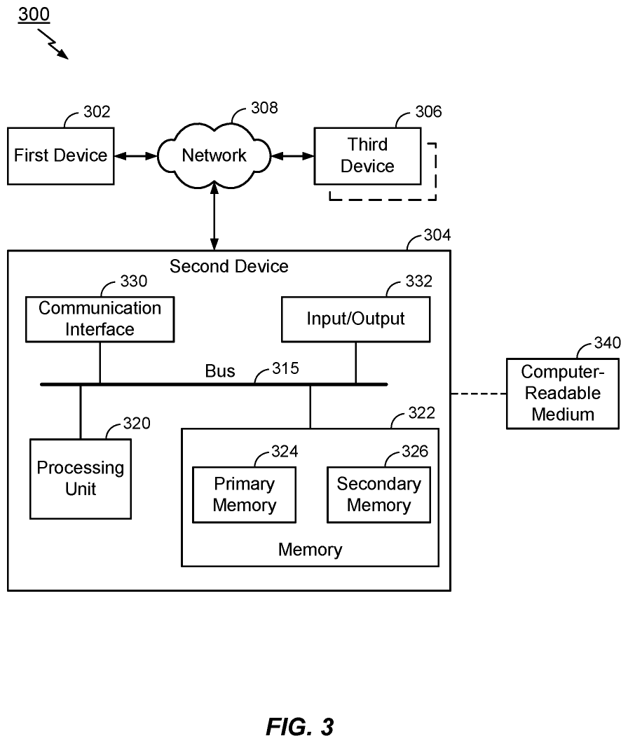

FIG. 3 is a schematic diagram illustrating an implementation of a computing device, such as computing device 220, in an example computing environment 300. In the embodiment of FIG. 3, first and third devices 302 and 306 may be capable of rendering a graphical user interface (GUI) on a display device coupled to computing device 220, for a network device and/or a computing device, for example, so that a customer service representative 210 may operate computing device 220. Second device 304 may potentially serve a similar function in this illustration. Likewise, in FIG. 3, first device 302 may interface with second device 304 by way of communication interface 330. Second device 304 may, for example, also comprise features of a client computing device and/or a server computing device, in an embodiment. Processing unit 320 and memory 322, which may comprise primary memory 324 and secondary memory 326, may communicate by way of a communication bus 315, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 304, as depicted in FIG. 3, is merely one example, and claimed subject matter is not limited in scope to this particular example.

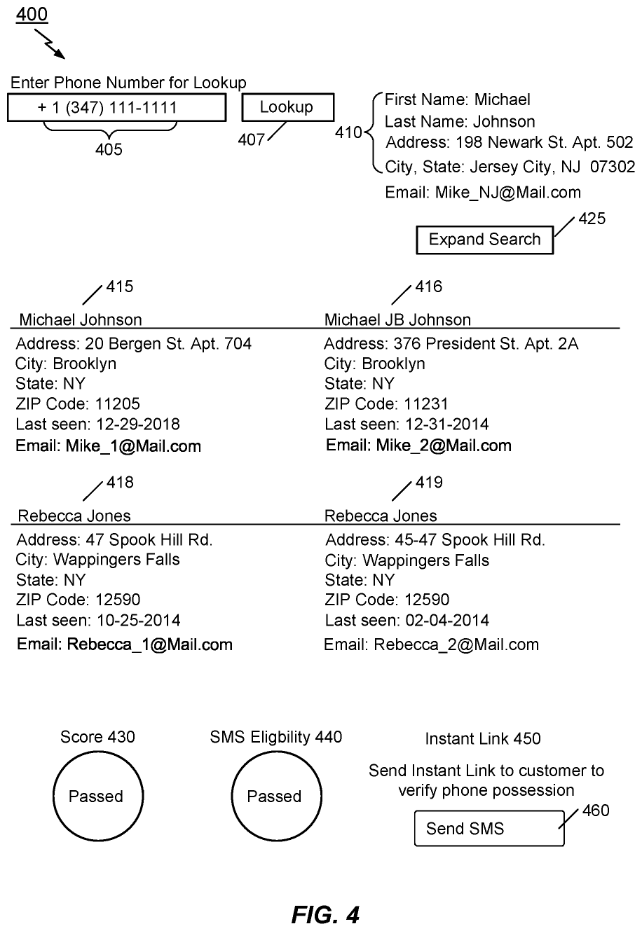

FIG. 4 is a diagram representing an example user interface, which a customer service representative, such as customer service representative 210, may view while auditing, authorizing and/or authenticating an identity of a transacting party, according to an embodiment 400. In particular embodiments, the user interface may be generated by computing device 220, as described in reference to FIGS. 2 and 3. In some embodiments, telephone number field 405 may be populated without user input, or may be manually entered by the customer service representative. It should be noted that although the “Phone Number for Lookup” corresponds to a US-style number form (such as a country code of “1,” followed by a three-digit parenthetical area code, three-digit prefix, and four-digit suffix), claimed subject matter is intended to embrace any type of number grouping, such as country codes other than those represented by “1,” area/locality codes having other than 3 digits, and so forth. In the embodiment of FIG. 4, responsive to manual entry or presentation of a telephone number corresponding to, for example, communications device 102 of FIGS. 1 and 2, a customer service representative, for example, may select “Lookup” selector 407. Responsive to selection of selector 407, an electronic records system, such as electronic records system 250 may be queried via a network 130. Responsive to such query, physical address information 410 may be returned, also via network 130, which may provide a subscriber associated with, or corresponding to the telephone number depicted in telephone number field 405. In particular embodiments, electronic records system 250 may additionally provide an email address, such as “Mike_NJ@Mail.com,” as depicted in FIG. 4. An email address may be obtained from email address records module 252, as discussed in reference to FIG. 2. In some embodiments, responsive to a query, a portion or subset of physical address information 410 may be returned, such as a subscriber's street name (but not necessarily house number), city, or town (but not necessarily a street name or house number). A portion or a subset of physical address information may be presented so as to remain in compliance with local privacy laws and/or practices. In some instances, instead of address-related or similar personally identifiable information, one or more particular designations (alphabetical, numeral, alphanumeric, etc.) may be generated and/or displayed to identify a party of interest. As a way of illustration, these one or more designations may be linked or associated with a transacting party (or any other suitable party, entity, etc.) so as to sufficiently identify the transacting party without disclosing personally identifiable information or any portion thereof.

In the embodiment of FIG. 4, physical address information 410 provided by electronic records system 250 may represent the physical address of a transacting party most likely to correspond to, or to be associated with, the telephone number depicted in telephone number field 405. However, in some embodiments, physical address information corresponding to other potential transacting parties associated with the telephone number depicted in telephone number field 405 may also be displayed in response to selecting “expand search” selector 425. In the particular instance of embodiment 400, transacting parties, such as individuals, having the same last name as transacting party 230 may be displayed, such as Michael Johnson (415) Michael J B Johnson (416), a first possible transacting party named Rebecca Jones (418), and a second possible transacting party named Rebecca Jones (419), along with respective physical address information, may also be provided by electronic records system 250. Further, in the embodiment of FIG. 4, email addresses for persons 415, 416, 418, and 419 may also be provided by electronic records system 250.

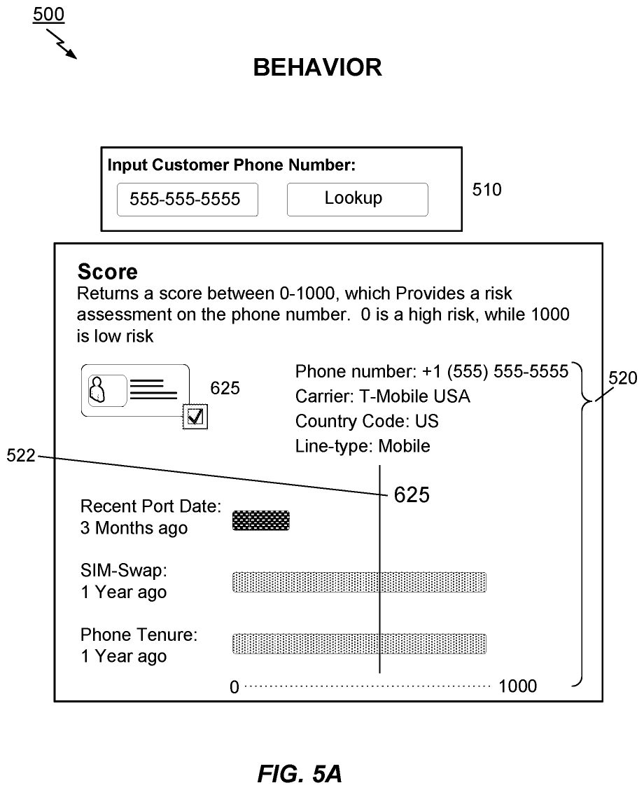

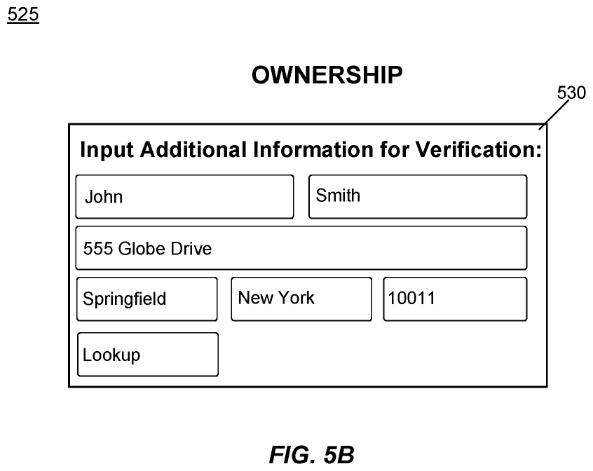

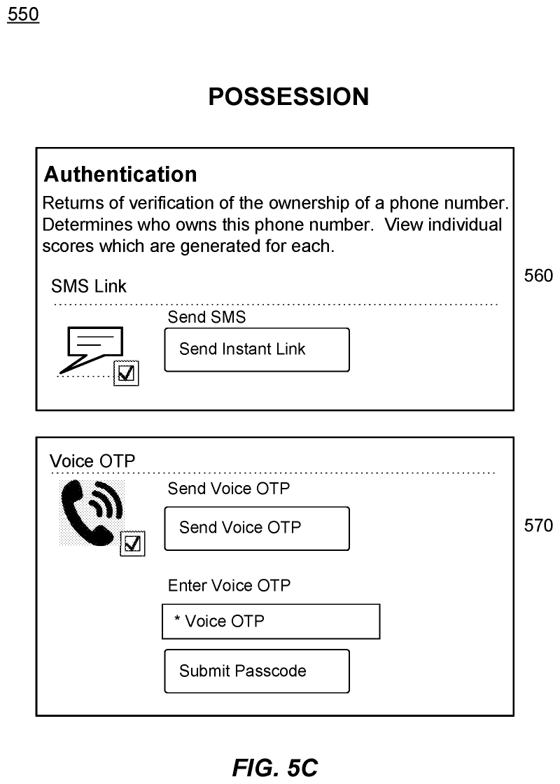

In the embodiment of FIG. 4, score 430, which may indicate “Passed” or “Failed” may relate to a risk event corresponding to behavior of communications device 102 of FIGS. 1 and 2. Score 430 may be derived in response to a determination of risk events associated with communications device 102. For example, as described in greater detail in FIG. 5A, a risk event corresponding to behavior of communications device 102 may correspond to a duration since the telephone number depicted in telephone number field 405 has been transferred or ported from a previous communications device to communications device 102. In particular embodiments, transferring or porting a telephone number from a previous communications device may be indicative of transacting party 230 acquiring a short-term or “burner” communications device, which may correspond to a relatively inexpensive mobile communications device designed for temporary use, after which the communications device may be discarded. In some instances, operation of a short-term mobile communications device may indicate that transacting party 230 does not wish to have his or her communications activities tracked. Such tracking may involve location information, identifiers (e.g., telephone numbers) associated with incoming or outgoing telephone calls, etc. In particular instances, use of such short-term communications devices may represent a risk event in that transacting party 230 may be engaged in surreptitious, untrustworthy, and/or unscrupulous activity. Accordingly, responsive to the telephone number depicted in telephone number field 405 corresponding to a short-term communications device, score 430 may indicate “Failed.” Conversely, responsive to the telephone number depicted in telephone number field 405 not corresponding to a short-term communications device, score may indicate “Passed.”

Another risk event that may influence score 430 may also correspond to a behavior of communications device 102 involving reporting swapping or removing/replacing of SIM 202. In some instances, removal/replacement of SIM 202 may be indicative of transacting party 230 attempting to fraudulently register a telephone number (or other identifier) belonging to a current subscriber of a mobile communications device services provider. In particular embodiments, removal/replacement of SIM 202 may permit an unscrupulous user to intercept notifications, fraudulently perform financial transactions, etc. Accordingly, in response to the telephone number depicted in telephone number field 405 corresponding to a mobile communications device that has recently been reported as having undergone removal/replacement of a SIM, score 430 may indicate “Failed.” Conversely, responsive to the telephone number depicted in telephone number field 405 not corresponding to a communications device that has recently been reported as having undergone removal/replacement of a SIM, score 430 may indicate “Passed.”

Another risk event that may influence score 430 may correspond to a behavior of communications device 102 involving the tenure or duration that transacting party 230 has owned or otherwise been associated with communications device 102. In some instances, responsive to transacting party 230 having owned and/or operated communications device 102 for an extended period of time, such as 2 years, 5 years, 10 years, etc., such duration may be indicative of a transacting party's financial stability. In such instances, increased tenure may indicate that transacting party 230 has made timely payments, over a substantial duration, for services rendered by a communication services carrier. Accordingly, responsive to the telephone number depicted in telephone number field 405 corresponding to a communications device that has been owned and/or operated by transacting party 230 for a relatively short period of time, score 430 may indicate “Failed.” Conversely, responsive to the telephone number depicted in telephone number field 405 corresponding to a mobile communications device that has been owned and/or operated by transacting party 230 for an extended period of time, score 430 may indicate “Passed.”

In addition to score 430, score 440 may indicate risk events related to the type of mobile communications device or other communications device utilized to contact customer service representative 210. For example, responsive to communications device 102 corresponding to a mobile cellular telephone, in which a wide variety of data relevant to transacting party 230 may be made available, such as current location, payment history for communication services, etc., these parameters may be perceived by customer service representative 210 as representing a low risk of fraud and/or unscrupulous behavior. Conversely, responsive to communications device 102 corresponding to a wireline or VoIP telephone, in which only limited data pertinent to transacting party 230 may be available, customer service representative 210 may perceive the presence of such limited data as representing a higher risk of fraud and/or unscrupulous behavior.

In addition to scores 430 and 440, score 450 may also be indicated, which may correspond to a risk event indicating whether transacting party 230 is in possession of communications device 102. In particular embodiments, possession of communications device 102 may be determined by computing device 220 conveying or transmitting a text message to the communications device. For example, while transacting party 230 is in communication with customer service representative 210, the customer service representative may initiate sending a numerical code (for example, 123456), which transacting party 230 may vocally annunciate. In another instance, customer service representative 210 may initiate conveying or transmitting any other unique or semi-unique code such as “the quick brown fox jumps.” It should be noted that claimed subject matter is intended to embrace any content, such as a numeric code, an alphanumeric code, or any other signal.

In particular embodiments, customer service representative 210 may initiate conveying or transmitting a hyperlink (for example, HTTP://www.hyperlink.com) via selection of “send SMS” selector 460. Responsive to the selection of selector 460, a hyperlink may be transmitted to communications device 102. Upon receipt of the hyperlink, transacting party 230 need only select the displayed hyperlink, which, in turn, may give rise to communications device 102 generating a signal indicating selection of such hyperlink. The signal may be conveyed back to customer service representative 210. Accordingly, in response to a display device coupled to computing device 220 not indicating receipt of the signal within an expected period of time (e.g., 5 seconds, 10 seconds, 15 seconds, 30 seconds) score 440 may indicate “Failed.” Conversely, responsive to a display coupled to computing device 220 indicating receipt of the signal within the expected period of time, score 440 may indicate “Passed.”

In particular embodiments, criteria for indicating whether a score, such as score 430, score 440, and/or score 450 represents whether a transacting party has passed or failed authentication may be configurable based, at least in part, on a configurable threshold that relates to an amount of a particular transaction. For example, responsive to a transacting party engaging in a transaction having relatively small monetary value (e.g., $20, $50 $100), a relatively low score (e.g., less than 500) may be sufficient to pass an authenticating process. Conversely, responsive to a transacting party engaging in a transaction having a relatively large monetary value (e.g., $500, $1000, or more), a relatively high score (e.g., greater than 600) may be needed to pass an authenticating process. In other instances, criteria for indicating whether a score represents whether a transacting party has passed or failed authentication may be configurable based on a particular type of transaction. For example, in response to a transacting party attempting to open a line of credit, a relatively high score may be needed to pass an authenticating process. Conversely, responsive to a transacting party engaging in a transaction to merely obtain access to a premium sports/entertainment television channel, a relatively low score may be sufficient to pass an authenticating process.

FIG. 5A is a diagram representing example behavior factors, which may be utilized by a customer service representative to audit, authorize, and/or authenticate identity of a transacting party, according to an embodiment 500. As depicted in FIG. 5A, field 510 comprises a field designated for input of (or perhaps simply display of) a phone number, for example, of transacting party 230. In embodiment 500, field 510 depicts a form corresponding to a United States-based telephone number. However, in other instances, field 510 may depict a telephone number having a form corresponding to a phone number corresponding to any other political entity (e.g., country, province, zone, etc.) and claimed subject matter is not limited in this respect. FIG. 5A additionally depicts field 520, which indicates a telephone number, a carrier, such as a mobile communications device services carrier, a country code, and a line type. It should be noted that although field 520 indicates a line type: Mobile, in other instances, a line type may correspond to a wireline telephone, a voice over Internet protocol (VoIP) telephone, or any other type of communications channel, and claimed subject matter is intended to embrace all such types.

Field 520 of FIG. 5A additionally comprises an indicator to indicate that transacting party 230 has recently ported a communications device identifier (e.g., a mobile telephone number) from a first communication services carrier to a second communication services carrier within a recent 3-month period. As indicated, such recent porting of communications device 102 may indicate an increased risk of fraud associated with transacting party 230. Field 520 of FIG. 5A, additionally includes an indication as to whether transacting party 230 has removed and/or replaced a SIM of communications device 102. As previously described herein, removal/replacement of a SIM (e.g., SIM-swap in FIG. 5A) may be indicative of transacting party 230 attempting to fraudulently register a telephone number belonging to a different subscriber of a mobile communications device services provider. Field 520 of FIG. 5A additionally includes an indication of phone tenure, which may provide an indication of a duration during which transacting party 230 has owned/operated communications device 102. As shown in FIG. 5A communications device 102 has not undergone a removal/replacement of a SIM for at least one year. Further, transacting party 230 has owned and/or operated (e.g., tenure) communications device 102 for at least one year.

Field 520 of FIG. 5A additionally includes an indicator 522, which provides a weighted or composite risk score (e.g., 625), which provides a measure of the combined or aggregate score attributed to behavioral aspects of communications device (102) of transacting party 230. In the embodiment of FIG. 5A, authentication or rejection of to transacting party may be based, at least in part, on a relationship between the composite risk score and a lower risk threshold. In particular embodiments, indicator 522 may be determined by way of averaging of indicators pertaining to recent mobile communications device telephone number porting, SIM removal/replacement, and device tenure. However, in other instances, indicator 522 may be determined by way of weighting such indicators in a manner that emphasizes certain indicators over other indicators. For example, in one possible embodiment, mobile communications device telephone number porting may be weighted so as to assign greater weight for such activities in relation to SIM removal/replacement and device tenure. In other instances, SIM removal/replacement may be weighted so as to assign greater weight in relation to mobile communications device telephone number porting and device tenure. It should be noted that claimed subject matter is intended to embrace a variety of weighting schemes, such as those that assign greater or lesser weights to certain mobile communications device behaviors in relation to other mobile communications device behaviors. Responsive to indicator 522 depicting a composite, average, or weighted average greater than a threshold value, a score may be indicated as “Passed” as depicted in score 430 of FIG. 4. Conversely, responsive to indicator 522 depicting a composite, average, or weighted average that is less than a threshold value, a score may be indicated as “Failed” as depicted in score 430 of FIG. 4.

FIG. 5B is a diagram representing example ownership factors, which may be utilized by a customer service representative to authorize a transaction initiated by a transacting party, according to an embodiment 525. As depicted in FIG. 5B, physical address details of transacting party 230 may be entered, or may be populated by a computing device, into ownership field 530. For example, ownership field 530 may represent the physical address parameters entered by customer service representative 210 for comparison with physical address parameters provided by electronic records system 250.

FIG. 5C is a diagram representing example possession factors, which may be utilized by a customer service representative to authenticate a transacting party, according to an embodiment 550. As depicted in FIG. 5C, possession factors may be arrived at via authentication, which may determine whether a transacting party is in possession of communications device 102. In particular embodiments, such authentication may be achieved via customer service representative 210, or an appropriate logic module operating in conjunction with the computing device, initiating transmission of message to communications device 102 utilizing selection box 560. In some embodiments, responsive to communications device 102 corresponding to a communications device, such as a processor-based or processor-enhanced cellular mobile communications device, a transmitted message may correspond to a SMS message. In particular embodiments, and SMS message may be translated responsive to detecting that a particular mobile telephone number, for example, corresponds to a particular country code. Thus, in one possible example, a mobile telephone number corresponding to a country in Latin America may be translated into Spanish, although claimed subject matter is not limited in this respect. By way of a customer service representative, or an appropriate computer-implemented customer service module, selecting to “Send Instant Link, a text message or hyperlink may be generated and transmitted to communications device 102. Upon receipt of the hyperlink, transacting party 230 need only select the displayed hyperlink, which, in turn, may give rise to communications device 102 generating a signal indicating selection of such hyperlink. The signal may be conveyed back to customer service representative 210. Responsive to detection that transacting party 230 has returned or selected (e.g., clicked on) the transmitted link, a score (e.g., Instant Link 450 of FIG. 4) may be increased. Responsive to detection that transacting party 230 has not returned (or clicked on) the transmitted link, a score (e.g., Instant Link 450) may be decreased.

In some embodiments, responsive to communications device 102 corresponding to a wireline device, such as a device operating in conjunction with the PSTN, a transmitted message may correspond to a voice-annunciated one-time password. For example, while transacting party 230 is in communication with customer service representative 210, the customer service representative may initiate sending of a numerical code (for example, 123456) utilizing a selector depicted in selection box 570, which transacting party 230 may vocally annunciate. In another instance, customer service representative 210 may initiate conveying or transmitting any other unique or semi-unique code such as “the quick brown fox jumps.” Responsive to receipt of the voice-annunciated one-time password vocalized, or entered (such as via DTMF signaling) by customer service representative 210, a comparison may be made between the transmitted and received passwords. Responsive to detection that transacting party 230 has annunciated the semi-unique code, a score (e.g., Instant Link 450 of FIG. 4) may be increased. Responsive to detection that transacting party 230 has not annunciated the semi-unique code, a score (e.g., Instant Link 450) may be decreased.

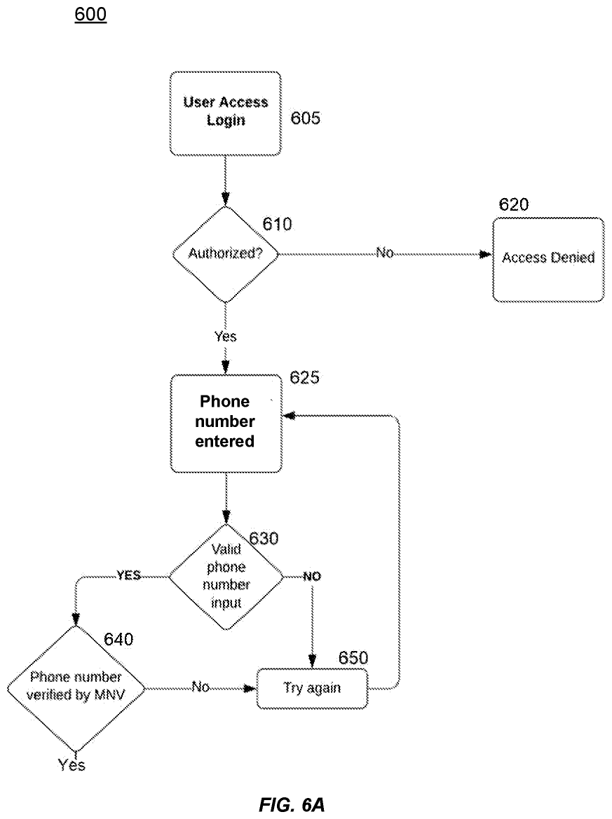

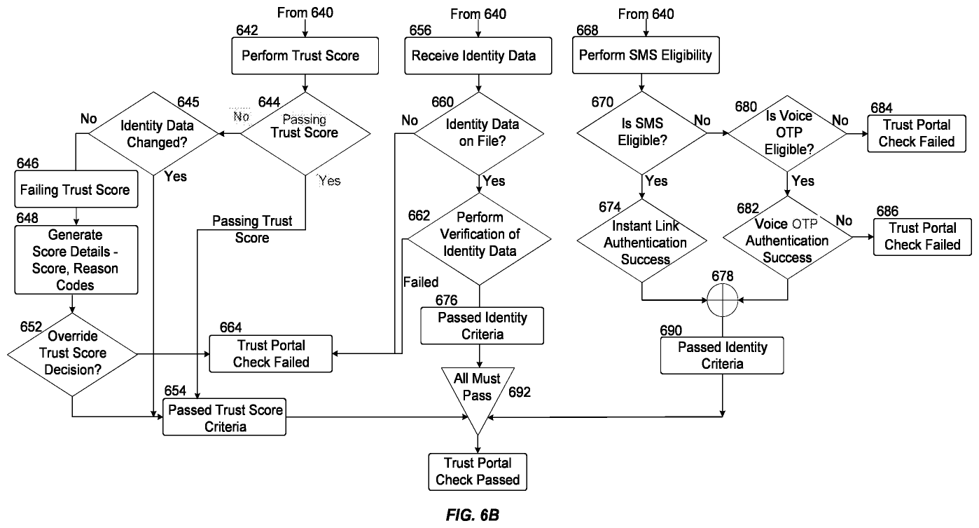

FIG. 6A is a first portion of a flow diagram illustrating an implementation of a Trust Portal electronic infrastructure, according to an embodiment 600. It should be noted that while operations are depicted in FIGS. 6A and 6B in a particular order, operations need not be performed in the particular order shown, or in sequential order, or that all illustrated operations be performed, to achieve desirable results. The method of FIG. 6A begins at operation 605, in which a user, such as customer service representative 210, obtains access to a login screen, which may be displayed via a display device in communication with a computing device. The method may proceed at operation 610, which includes determining whether the customer service representative, for example, is authorized to proceed with auditing, authorizing, and/or authenticating transactions, such as transactions initiated by transacting party 230. Responsive to operation 610 determining that the customer service representative, for example, is not authorized to perform auditing, authorizing, authenticating a transacting party, the method terminates at operation 620, in which further operations are denied. Conversely, responsive to operation 610 determining that the customer service representative (or software module(s) performing one or more customer service representative functions) is authorized to perform auditing, authorizing, authenticating of transacting party 230, the method continues at operation 625.

Operation 625 includes receiving a phone number entered by a customer service representative. In some embodiments, operation 625 includes a customer service representative entering a phone number vocalized or annunciated by transacting party 230. In some embodiments, operation 625 includes a computing device automatically providing, such as without user input, a phone number (or other type of identifier) associated with a communications device in the possession of transacting party 230. At operation 630, a computing device, which may access an electronic records system (for example, electronic records system 250 of FIG. 2), a customer service representative, and/or a logic module executed by a computing device, may determine whether the phone number corresponding to transacting party 230 corresponds to one or more acceptable forms, such as a US-style number form (such as a country code of “1,” followed by a three-digit parenthetical area code, a three-digit prefix, and a four-digit suffix). Responsive to determining that the phone number of the transacting party corresponds to one or more acceptable forms, operation 640 may be performed. Responsive to determining that the phone number of the transacting party does not correspond to one or more acceptable forms, operation 650 may be performed, which may include providing an opportunity for transacting party 230 (or customer service representative 210) to re-enter a telephone number.

Operation 640 may include verifying, such as by way of Mobile Number Verification, to determine whether the entered phone number corresponds to a mobile communications device, VoIP communications device, or a landline operating via the PSTN. In particular embodiments, Mobile Number Verification may be achieved utilizing a tool such as that provided by TeleSign at 13274 Fiji Way, Suite 600, Marina del Rey, California (www.telesign.com). Responsive to determining at operation 640 that the entered number does not correspond to a mobile communications device, operation 650 is performed in which the number may be entered a second time. Conversely, responsive to an entered phone number corresponding to a mobile communications device, VoIP communications device or landline operating via the PSTN, the method may proceed, such as described in FIG. 6B.

FIG. 6B shows a second portion of a flow diagram illustrating an example implementation of a Trust Portal electronic infrastructure, according to an embodiment. Responsive to operation 640 which includes determining that an entered phone number corresponds to a mobile communications device, a VoIP communications device, or a landline operating via the PSTN, the method of FIG. 6B proceeds at operation 642, 656, and 668. It should be noted that operations 642, 656, and 668 can be performed simultaneously, or in sequential order, and claimed subject matter is not limited in this respect. In particular embodiments, operation 642 may signify an initial portion of an “auditing” subprocess, in which the behavior of the communications device associated with transacting party 230 is audited to obtain a score. In particular embodiments, operation 656 may signify an initial portion of an “authorizing” subprocess, in which a particular transaction initiated by transacting party 230 is authorized. In particular embodiments, operation 668 may signify an initial portion of an “authentication” subprocess, in which transacting party 230 is verified as being associated with a particular communications device.

At operation 642, a computing device may compute or retrieve a previously computed score, such as described in reference to FIG. 5A. As described in reference to FIG. 5A, factors such as whether transacting party 230 has recently ported (e.g., within 1 month, 3 months, 6 months, etc.) a telephone number or other type of identifier from a first communications device to a second communications device may enhance or degrade a computed score. In addition, whether transacting party 230 has removed/replaced a SIM from a first mobile communications device to a second communications device may enhance or degrade a computed score. Further whether transacting party 230 has owned/operated mobile communications device having a particular telephone number (or other type of identifier) for a threshold period of time, such as 1 year, 2 years, 5 years, or other duration, may enhance or degrade a computed score.

At operation 644, a score is evaluated to determine whether the score computed or retrieved at operation 642 satisfies a threshold (such as a lower threshold) value. In response to determining that a score satisfies a threshold, the method may proceed to operation 654, in which such score is indicated as comprising a value sufficient to indicate that the auditing subprocess of FIG. 6B has been successfully completed. In such an instance, a computing device, such as a computing device operated by customer service representative 210, may display a “Passed” indicator (such as “Passed” indicator 430 of FIG. 4). On the other hand, responsive to the evaluating operation of 644 determining that the computed or retrieved score does not satisfy a threshold, such as a lower threshold, operation 645 is performed as an initial step toward determining, with greater precision, factors which bring about a score less than a lower threshold. Operation 644 may involve the generation of a “reason code,” or other type of indicator, that can be utilized by a customer service representative (or a computer-implemented logic module performing one or more customer service representative functions) to bring forth one or more factors contributing to a score less than a lower threshold.

Operation 645, perhaps in response to a reason code indicating that a persistent mobile identifier has recently changed (such as within 1 month, 3 months, 1 year), or cannot be accessed by, for example, an electronic records system (such as electronic records system 250), transacting party 230 may be queried to determine whether transacting party 230 can be associated with an alternative persistent mobile identifier. In another embodiment, transacting party 230 may be queried to determine more precise rationale for the unavailability of a persistent mobile identifier. Accordingly, responsive to transacting party 230 supplying a persistent mobile identifier, operation 646 may be performed in which additional reason codes (or other type of indicator) is evaluated to determine the one or more factors contributing to a score less than a lower threshold. At operation 648, additional score details may be displayed, such as by way of a display similar to that of FIG. 5A, to indicate factors that may have degraded a score. In some instances, transacting party 230 may be queried to provide explanation relevant to recent phone number porting, recent swapping of a SIM, phone tenure less than a threshold period of time, and/or other factors that may have degraded a score. It is contemplated that, at least in particular instances, that recent phone number porting or SIM removal/replacement, for example, may have been due to reported loss or theft of a mobile communications device. In other instances, an otherwise trustworthy transacting party may have recently (and legitimately) upgraded a communications device.

With respect to reason codes displayed at operation 648, it may be appreciated that certain reason codes contributing to a score, such as a score less than a lower threshold, may be in response to risk events having greater or lesser significance. For example, in response to a computed or retrieved score being only slightly lower than a lower threshold, a reason code corresponding to mobile communications device tenure being marginally below a desired threshold (such as a tenure of four years and 11 months versus a threshold tenure of five years, for example), a small amount of additional information from a transacting party may be sufficient to satisfy mobile communications device auditing criteria. However, in other instances, such as mobile communications device number porting within the past one month (for example), or a SIM swapping within one month (for example), may necessitate a much more significant amount of additional information from a transacting party to satisfy mobile communications device auditing criteria. Thus, it may be appreciated that certain reason codes may have greater impact on a score than other reason codes. In addition, certain reason codes may necessitate greater or lesser supporting rationale and/or additional information to satisfy mobile communications device auditing criteria so that a particular transaction can occur.

Subsequent to performing operation 648, operation 652 may be performed. Operation 652 may include a customer service representative (or a computer-implemented process performing one or more functions of a customer service representative) overriding a score being less than (or “failing”) a lower threshold. Responsive to a transacting party supplying sufficient additional information and/or rationale, operation 654 may be performed, in which a score, such as score 430, may indicate that the transacting party has “passed” a mobile communications device audit. Conversely, responsive to a transacting party supplying insufficient additional information and/or rationale, operation 664 may be performed, in which a score, such as score 430, may indicate that the transacting party has “failed” a mobile communications device audit.

Returning briefly to the outcome of operation 640, which includes verifying, such as by way of Mobile Number Verification, operation 656 may be performed. As previously mentioned, operation 656 may signify an initial portion of an “authorizing” subprocess, in which a particular transaction initiated by transacting party 230 is authorized. In particular embodiments, operation 656 includes a customer service representative, or a computer-implemented module performing functions of a customer service representative, verifying the identity of a transacting party. In some instances, operation 656 can include retrieving identity information from a transacting party, such as name, physical address (or subset of physical address information), email address, Social Security number, tax identification number, etc. The method may continue at operation 660, in which provided identity information from a transacting party can be compared with identity information retrieved from an electronic records system. Responsive to a substantial match between provided identity information of a transacting party and identity information of a transacting party from an electronic records system, operation 662 may be performed, which may include a customer service representative visually comparing provided transacting party information and transacting party information retrieved from an electronic records system. In some instances, comparison may involve computer-implemented comparison without involving a human customer service representative. Responsive to a positive outcome of operation 662, operation 676 may be performed, in which a score, such as score 430, may indicate that the transacting party has “passed” an authorizing process.

Conversely, responsive to a negative outcome of operation 660, in which provided identity information from a transacting party cannot be matched with identity information retrieved from an electronic records system, such as in response to little or no identity information being available from an electronic records system, the method may proceed to operation 664. At operation 664, a score, such as score 430, may indicate that the transacting party has “failed” an authorizing process.

Returning briefly to the outcome of operation 640, which includes verifying, such as by way of Mobile Number Verification, operation 668 may be performed. As previously mentioned, operation 668 may signify an initial portion of an “authenticating” subprocess, in which transacting party 230 is authenticated. In particular embodiments, operation 670 includes a customer service representative, or a computer-implemented module performing functions of a customer service representative, determining whether a mobile communications device associated with a transacting party (for example, communications device 102) is capable (or eligible) of receiving a SMS message. Responsive to the determination that communications device 102 is capable (or eligible) to receive an SMS message, operation 674 may be performed, which may include a customer service representative (or a computer-implemented logic module performing functions of a customer service representative) initiating transmission of a text message, which may include a hyperlink, via a “send SMS” selector (for example, “send SMS” selector 460 of FIG. 4). Upon receipt of the hyperlink, transacting party 230 may select a displayed hyperlink, which, in turn, may give rise to communications device 102 generating a signal indicating selection of such hyperlink. The signal may be conveyed back to a customer service representative. Responsive to receipt of an indication that the transacting party has successfully selected the transmitted hyperlink, a score, such as score 430, may indicate that the transacting party has “passed” an authenticating process. Conversely, at operation 664, a score, such as score 430, may indicate that the transacting party has “failed” an authenticating process.

As previously pointed out, communications device 102 may comprise a wireline device, such as a device operating in conjunction with the PSTN. Thus, in particular embodiments, in response to operation 670 determining that a communications device associated with a transacting party does not correspond to a mobile communications device, operation 680 may be performed. At operation 680, a customer service representative, such as by way of accessing an electronic records system, may determine that a communications device of a transacting party is eligible to receive a one-time password. In such case, a customer service representative, or one or more software modules performing customer service representative functions, may generate a one-time password (OTP) and convey the one-time password (such as a numerical code) to a transacting party, such as at operation 682. Responsive to annunciation of the one-time password by the customer service representative (or the one or more software modules performing customer service representative functions) a transacting party may recite the one-time password for comparison by the customer service representative, for example. Responsive to receipt of a correctly-annunciated one-time password from a transacting party, a score, such as score 430, may indicate that the transacting party has “passed” an authenticating process, such as at operation 684. Conversely, responsive to an incorrectly-annunciated one-time password from a transacting party operation, a score, such as score 430, may indicate that the transacting party has “failed” an authenticating process, such as at operation 686.

Operation 678 may include determining whether a customer service representative, for example, has received a signal indicating selection of the hyperlink by way of a transacting party's mobile communications device (operation 674) or whether the customer service representative, for example, has received a correctly-annunciated one-time password from a transacting party (operation 682). A score, such as score 430, may indicate that the transacting party has “passed” an authenticating process. At operation 690, responsive to a correctly-annunciated one-time password from a transacting party, or responsive to selection of a hyperlink by a transacting party, operation 690 may be performed, in which a score, such as score 430 may indicate that the transacting party has “passed” an authenticating process.

Responsive to successful completion of an “auditing” subprocess, such as initiated at operation 642 (and continuing at operation 654), and responsive to successful completion of an “authorizing” subprocess, such as initiated at operation 656 (and continuing at operation 676), and responsive to an “authentication” process, such as initiated at operation 668 (and continuing at operation 690), operation 692 may be performed. At operation 692, responsive to all of an “auditing,” “authorizing,” or “authenticating” processes being successfully completed, a transaction initiated by a transacting party may be permitted to occur. Conversely, responsive to one of an “auditing,” “authorizing,” or “authenticating” processes not successfully occurring, a customer service representative, or one or more software modules performing functions of a customer service representative, may be notified that the transaction has failed.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to cooperate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present patent application, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, Md., 21050-2747), but may include other aspects, such as the Hadoop distributed file system (HDFS) (available from the Apache Software Foundation, 1901 Munsey Drive, Forrest Hill, Md., 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present patent application, use of the term “Hadoop” is intended to include versions, presently known and/or to be later developed.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

In the context of the present patent application, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present patent application, may comprise a service that organizes stored digital content, such as, for example, text, images, video, etc., through the use of hypermedia, for example. It is noted that a network, such as the Internet and/or Web, may be employed to store electronic files and/or electronic documents.

The term electronic file and/or the term electronic document are used throughout this document to refer to a set of stored memory states and/or a set of physical signals associated in a manner so as to thereby, at least logically, form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the term “Web site” and/or similar terms refer to Web pages that are associated electronically to form a particular collection thereof. Also, in the context of the present patent application, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

In the context of the present patent application, the terms “entry,” “electronic entry,” “document,” “electronic document,” “content”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. The lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2^{nd}, 3^{rd}, 4^{th}, 5^{th} generation (2G, 3G, 4G, or 5G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), 802.11b/g/n, and/or the like. A wireless network may include virtually any type of now known and/or to be developed wireless communication mechanism and/or wireless communications protocol by which signals may be communicated between devices, between networks, within a network, and/or the like, including the foregoing, of course.

An example embodiment of FIG. 3, a system embodiment may comprise a local network (e.g., device 304 and medium 340) and/or another type of network, such as a computing and/or communications network. For purposes of illustration, therefore, FIG. 3 shows an embodiment 300 of a system that may be employed to implement either type or both types of networks. Network 308 may comprise one or more network connections, links, processes, services, applications, and/or resources to facilitate and/or support communications, such as an exchange of communication signals, for example, between a computing device, such as 302, and another computing device, such as 306, which may, for example, comprise one or more client computing devices and/or one or more server computing device. By way of example, but not limitation, network 308 may comprise wireless and/or wired communication links, telephone and/or telecommunications systems, Wi-Fi networks, Wi-MAX networks, the Internet, a local area network (LAN), a wide area network (WAN), or any combinations thereof.

Returning briefly to FIG. 3, devices of FIG. 3 may comprise features, for example, of a client computing device and/or a server computing device, in an embodiment. It is further noted that the term computing device, in general, whether employed as a client and/or as a server, or otherwise, refers at least to a processor and a memory connected by a communication bus. Likewise, in the context of the present patent application at least, this is understood to refer to sufficient structure within the meaning of 35 USC § 112 (f) so that it is specifically intended that 35 USC § 112 (f) not be implicated by use of the term “computing device” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 3 and in the text associated with the foregoing figure of the present patent application.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). As suggested previously, a computing device and/or a networking device may also have a subscriber identity module (SIM), which, for example, may comprise a detachable or embedded smart card that is able to store subscription content of a user, and/or is also able to store a contact list. It is noted, as previously mentioned, that a SIM may also be electronic in the sense that it may simply be sorted in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

Returning briefly to FIG. 3, computing device 302 may provide one or more sources of executable computer instructions in the form physical states and/or signals (e.g., stored in memory states), for example. Computing device 302 may communicate with computing device 304 by way of a network connection, such as via network 308, for example. As previously mentioned, a connection, while physical, may not necessarily be tangible. Although computing device 304 of FIG. 3 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 322 may comprise any non-transitory storage mechanism. Memory 322 may comprise, for example, primary memory 324 and secondary memory 326, additional memory circuits, mechanisms, or combinations thereof may be used. Memory 322 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 322 may be utilized to store a program of executable computer instructions. For example, processor 320 may fetch executable instructions from memory and proceed to execute the fetched instructions. Memory 322 may also comprise a memory controller for accessing device readable-medium 340 that may carry and/or make accessible digital content, which may include code, and/or instructions, for example, executable by processor 320 and/or some other device, such as a controller, as one example, capable of executing computer instructions, for example. Under direction of processor 320, a non-transitory memory, such as memory cells storing physical states (e.g., memory states), comprising, for example, a program of executable computer instructions, may be executed by processor 320 and able to generate signals to be communicated via a network, for example, as previously described. Generated signals may also be stored in memory, also previously suggested.

Memory 322 may store electronic files and/or electronic documents, such as relating to one or more users, and may also comprise a computer-readable medium that may carry and/or make accessible content, including code and/or instructions, for example, executable by processor 320 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 3, processor 320 may comprise one or more circuits, such as digital circuits, to perform at least a portion of a computing procedure and/or process. By way of example, but not limitation, processor 320 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 320 may perform signal processing, typically substantially in accordance with fetched executable computer instructions, such as to manipulate signals and/or states, to construct signals and/or states, etc., with signals and/or states generated in such a manner to be communicated and/or stored in memory, for example.

Returning briefly to FIG. 3, device 304 is illustrated as including a component 332 operable with input/output devices, for example, so that signals and/or states may be appropriately communicated between devices, such as device 304 and an input device and/or device 304 and an output device. A user may make use of an input device, such as a computer mouse, stylus, track ball, keyboard, and/or any other similar device capable of receiving user actions and/or motions as input signals. Likewise, for a device having speech to text capability, a user may speak to generate input signals. Likewise, a user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method of authenticating a transacting party, comprising:
receiving, at a display device, electronic signals that relate to the transacting party operating a communications device;
accessing, by a computing device in communication with the display device, electronic records to determine whether one or more risk events have occurred with respect to the communications device; and
generating signals indicating a determination as to whether a transaction initiated by the transacting party is to proceed based, at least in part, on a score dependent upon the one or more risk events indicated by the electronic records.

2. The method of claim 1, wherein the communications device comprises a mobile communications device and wherein the one or more risk events correspond to porting an identifier of the mobile communications device, removal and/or replacement of a subscriber identity module (SIM) of the mobile communications device, or one or more risk events related to tenure of the mobile communications device.

3. The method of claim 2, further comprising combining a risk score, corresponding to porting the identifier of the mobile communications device, with a risk score corresponding to the removal and/or replacement of the subscriber identity module (SIM) of the mobile communications device, and/or with the one or more risk events related to tenure of the mobile communications device, to form a composite risk score.

4. The method of claim 3, wherein authenticating the transacting party operating the mobile communications device is based, at least in part, on the composite risk score exceeding a threshold.

5. The method of claim 4, wherein the threshold corresponds to a configurable threshold, the configurable threshold being selected based, at least in part, on the transaction initiated by the transacting party.

6. The method claim 1, further comprising accessing, by the computing device in communication with the display device, prior to authenticating the transacting party, one or more email addresses corresponding to the transacting party.

7. The method claim 1, further comprising initiating, by the computing device in communication with the display device, initiating transmission of a text message to the communications device.

8. The method claim 1, further comprising determining whether the transaction initiated by the transacting party is to proceed based on communications device behavior, authorizing the transacting party to engage in the transaction, and/or authenticating the transacting party.

9. An apparatus to authenticate a transacting party, comprising:
at least one processor communicatively coupled to at least one memory to:
access, by the at least one processor, electronic records to determine whether one or more risk events has occurred with respect to a communications device proximate with a transacting party; and
authorize or reject the transaction based, at least in part, on the one or more risk events indicated by the electronic records.

10. The apparatus of claim 9, wherein the at least one processor communicatively coupled to the at least one memory is to authorize or reject the transaction based computation of a risk score based on a risk score, corresponding to porting an identifier of a mobile communications device, with a risk score corresponding to removal and/or replacement of the subscriber identity module (SIM) of the mobile communications device, and/or with the one or more risk events related to tenure of the mobile communications device, to form a composite risk score.

11. The apparatus of claim 10, wherein the authorization or rejection of the transaction are based on a configurable threshold, the configurable threshold being selected based, at least in part, on a transaction initiated by the transacting party.

12. The apparatus of claim 11, wherein the at least one processor communicatively coupled to the at least one memory are to authorize the transaction based, at least in part, on the risk score exceeding the configurable threshold.

13. The apparatus of claim 11, wherein the at least one processor communicatively coupled to the at least one memory are to reject the transaction based, at least in part, on the risk score falling below the configurable threshold.

14. An article comprising:
a non-transitory storage medium having instructions stored thereon executable by a special purpose computing platform to:
access, by at least one processor coupled to at least one memory, electronic records to determine whether one or more risk events has occurred with respect to a communications device of a transacting party; and
authenticate or reject the transacting party based, at least in part, on the one or more risk events indicated by the electronic records.

15. The article of claim 14, wherein the communications device comprises a mobile communications device, and wherein the one or more risk events corresponding to mobile communications device number porting, removal and/or replacement of a subscriber identity module (SIM) of the mobile communications device, or one or more risk events related to tenure of the communications device.

16. The article of claim 15, wherein the stored instructions are additionally to combine a risk score corresponding to porting an identifier of the mobile communications device with a risk score corresponding to the removal and/or replacement of the subscriber identity module (SIM) of the mobile communications device, and/or with the one or more risk events related to tenure of the mobile communications device, to form a composite risk score.

17. The article of claim 16, wherein the authentication or rejection of the transacting party is based, at least in part, on a relationship between the composite risk score and a lower risk threshold.

18. The article of claim 16, wherein the risk score corresponding to the porting of the identifier of the mobile communications device and the risk score corresponding to the removal and/or replacement of the SIM are related to a duration since the porting and a duration since the removal and/or replacement of the SIM.

19. The article of claim 16, wherein the stored instructions are to authorize or reject the transaction based on a configurable threshold, wherein the configurable threshold is selected based, at least in part, on a transaction initiated by the transacting party.

20. The article of claim 19, wherein the configurable threshold pertains to a monetary amount involved in a financial transaction.
